(19) United States
(12) Patent Application Publication
(10) Pub. No.: US 2014/0028075 A1
(43) Pub. Date: Jan. 30, 2014

(54) Retractor Mounted Belt Tension Sensor

(71) Applicants: Kenneth H. Kohlndorfer, Roseville, MI (US); David Prentkowski, Sterling Heights, MI (US)

(72) Inventors: Kenneth H. Kohlndorfer, Roseville, MI (US); David Prentkowski, Sterling Heights, MI (US)

(73) Assignee: AUTOLIV ASP, Inc., Ogden, UT (US)

(21) Appl. No.: 13/560,451

(22) Filed: Jul. 27, 2012

(51) Int. Cl. B60R 22/34

(52) U.S. Cl. 297/475

(57) ABSTRACT

A seat belt retractor for providing extraction and retraction of seat belt webbing incorporating a belt tension sensing mechanism. The sensing mechanism includes a webbing guide which is moveable between positions and is biased toward a low tension position by a restoring spring force. The belt webbing is routed to deflected path through the web guide. Increasing tension on the webbing will cause the web guide to change its position as the webbing path straightens. The position of the web guide is detected through an electrical switch to provide a measure of webbing tension.

### FIELD OF THE INVENTION

This invention relates to a motor vehicle occupant restraint system and particularly to a seat belt retractor incorporating a belt tension sensing function.

### BACKGROUND OF THE INVENTION

Seat belt occupant restraint systems are in widespread use in modern day motor vehicles. Seat belt systems typically include a seat belt retractor for retracting and allowing extension of belt webbing by stowing the webbing on a rotatable spool. Belt systems are typically of the three-point active type, incorporating a buckle and latch plate arrangement for fastening and unfastening the belt restraint around the occupant. Belt restraint systems have been shown to produce significant benefits to occupants involved in motor vehicle collisions and rollover incidents. Typical modern day seat belt retractors are either of the emergency locking retractor (ELR), automatic locking retractor (ALR), or a hybrid type providing both functions. An ELR includes an inertia sensitive element within the retractor which locks the retractor spool upon sensing a rollover condition or a lateral acceleration exceeding a predetermined magnitude. The ALR operates as a one-way clutch, allowing full extraction of the webbing from the retractor, and then retraction is clutched to prevent further withdrawal of webbing. Dual mode (hybrid) retractors are also widely available. ELR's have the benefit of enhanced occupant comfort and convenience for the seated occupant since it allows the free extraction of webbing during movement within the vehicle in non-emergency conditions. ALR's on the other hand have a tendency to cinch down and can be uncomfortable for occupants in certain conditions. However, ALR's have the significant benefit when used with a child restraint system (also referred to as child safety seats, infant safety seats, and child car seats) in that they can be cinched down to securely engage the child restraint system and position it in the seat securely.

Motor vehicle manufacturers and occupant restraint systems suppliers incorporate systems in some vehicle models, particularly in front passenger seat applications, to detect the presence of a child restraint system. This is important since it is desirable not to deploy frontal impact inflatable restraint systems when child restraint systems are fastened to a seat. Some vehicles rely upon a manual switch activated by the vehicle driver to disable a frontal inflatable restraint system, but is preferred and in some cases required by regulations to provide automated systems to prevent inadvertent failure to disable a frontal impact airbag when a child restraint system is mounted. Some automotive systems use non-contact sensors to detect the presence of a child restraint system based on video, ultrasonic or electronic field sensing technologies or seat pressure sensing systems.

Another class of devices used to detect the presence of a child restraint system mounted to a seat is a belt tension sensor. These devices detect the constant tension exerted on the lap portion of a seat belt as an indicator of a mounted child seat when the retractor is in the ALR mode. This is accomplished by measuring the tension force, typically at about 30 pounds or more in the webbing after the child seat has been installed. Such a sensor device is usually attached to the anchor end of the webbing, attached to the buckle, or integrated into the buckle. These systems work well, but with significant price impact due to the cost of a sensor assembly or a complex buckle with an integrated tension sensor.

In view of the foregoing, there is a need to provide a system for detecting seat belt webbing tension without the requirement of a separately installed belt tension sensor.

### SUMMARY OF THE INVENTION

In accordance with the present invention, a belt tension sensing mechanism is integrated into the seat belt retractor. The system operates on the principle of causing the webbing to engage a webbing guide and undergo a deflected path whereby tension in the seat belt webbing acts on the webbing guide to move it against the force of a spring as the belt is straightened. By detecting the deflection of the web guide, web tension can be measured. The system in accordance with this invention provides an extremely compact assembly without requiring a separately installed tension sensing assembly component.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a frontal view of a motor vehicle occupant seated in a vehicle seat fastening a typical three-point seat belt restraint;

FIG. 2 is pictorial view of a retractor in accordance with the present invention;

FIG. 3 is a cross-sectional view through the retractor shown in FIG. 2 with the webbing in a low tension condition; and

FIG. 4 is a view similar to FIG. 3, but showing the webbing in a high tension condition.

FIG. 5 is a view similar to FIG. 3 showing a second embodiment of the present invention.

### DETAILED DESCRIPTION OF INVENTION

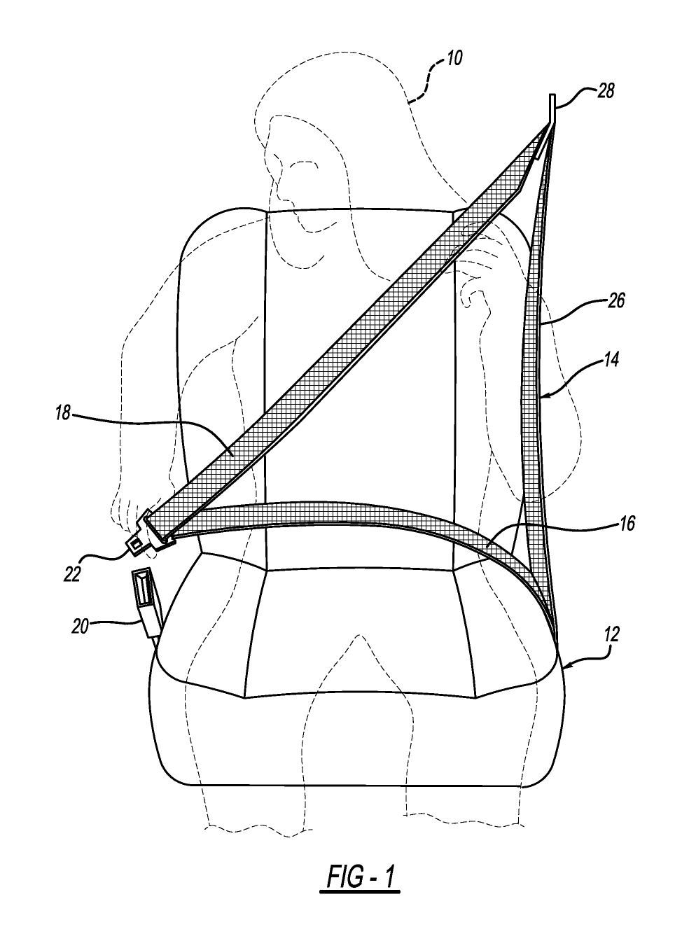

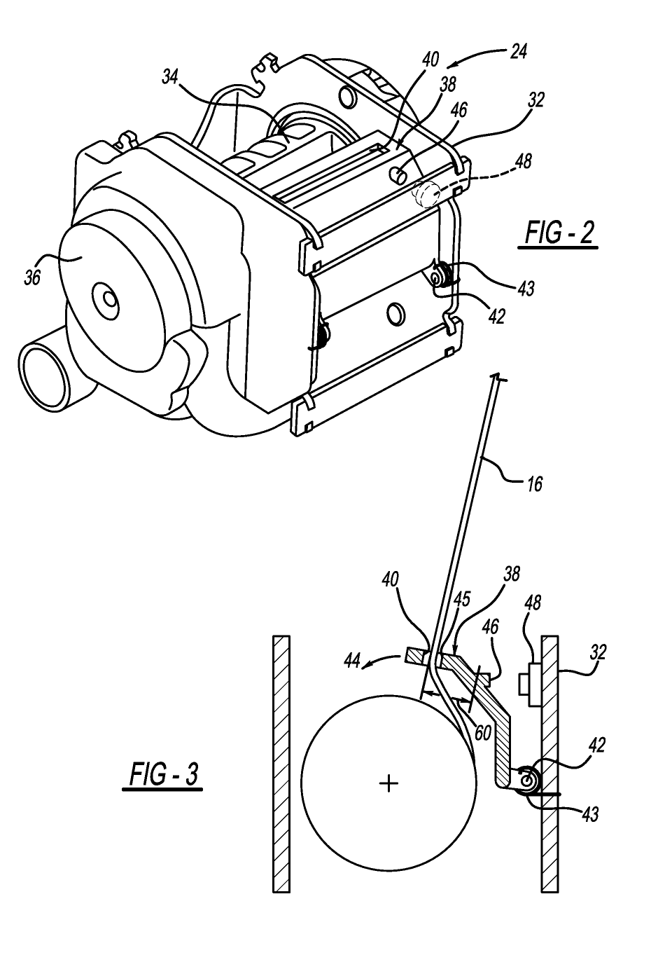

With reference to FIG. 1, there is illustrated in phantom lines an occupant 10 seated in a motor vehicle occupant seat 12. Occupant 10 is shown fastening a three-point belt restraint system 14. Restraint system 14 typically includes elements including lap belt portion 16, shoulder belt section 18, buckle 20, and latch plate 22. A seat belt retractor 24 (shown in FIG. 2), is used for engaging an end of the downward extending section 26 of shoulder belt section 18, and is used for allowing extraction and retraction of the seat belt webbing. Retractor 24 can be mounted in various locations such as on seat 12, on the floor pan of the vehicle adjacent the side of the seat, or behind a trim panel on a vertical door pillar at the position of guide loop 28 as shown in FIG. 1.

Now with reference to FIG. 2, retractor 24 is shown in greater detail. Retractor 24 may take various forms within the spirit and scope of the present invention. In its simplest form, retractor 24 includes frame 32 with spool 34 mounted for rotation within the frame. Spool 34 is shown in FIG. 2 without any belt webbing wrapped on it for the sake of illustration. In use, seat belt webbing would be wrapped upon the spool 34. Retractor 24 incorporates torsional rewind spring 36 which exerts a constant rotational force on spool 34, urging the spool to retract the webbing. Retractor 24 further may include various other functional elements including inertia sensing systems for ELR functions, pretensioning functions for reducing slack of webbing during an impact event, load limiting features, and other systems found in modern high-performance belt retractors.

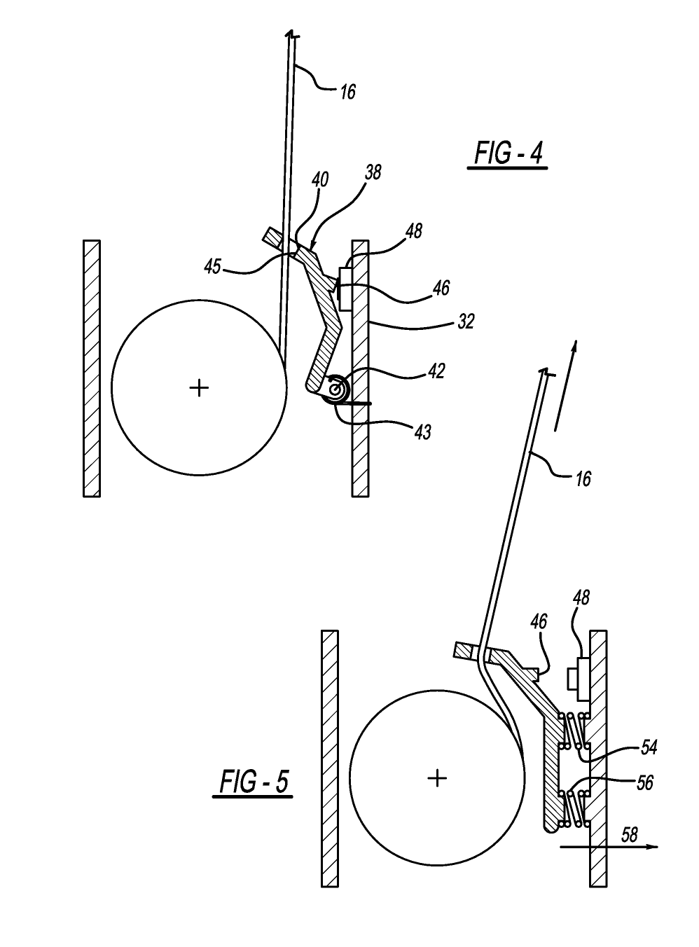

As best shown in FIG. 3, retractor 24 incorporates a pivoting web guide 38 which is mounted to retractor frame 32 to move through a limited rotational range. Web guide 38 incorporates webbing slot 40 through which webbing section 16 passes. Slot 40 forms an edge 45 which contacts the webbing. Pivoting web guide 38 is capable of rotational motion about pivot point 42. Torsion spring 43 is installed to urge web guide 38 toward the counterclockwise direction, designated by arrow 44. Web guide abutment surface 46 is provided to engage with microswitch 48. Microswitch 48 can be a type depending on actual contact with abutment surface 46 to change its electrical state or could be based on proximity sensing technologies. For example, microswitch 48 could incorporate a Hall effect device sensitive to a change in magnetic field which can be influenced by the position of the web guide 38. For such application, abutment surface 46 could be comprised of a small magnet, or the abutment surface could be part of a magnetic circuit influencing the strength of a magnetic field acting on a Hall element produced by a fixed permanent magnet. For any of the various types of switching devices, the switch 48 provides a differential output depending on the position of web guide 38 being in the low belt tension position illustrated in FIG. 3 and the high tension position shown in FIG. 4.

As indicated in FIG. 3, webbing section 26 undergoes a deflected routing as it passes through web guide slot 40 and engages edge 45. If tension is exerted on webbing exceeding some threshold, i.e. about 30 pounds, the webbing straightens and urges web guide 38 to rotate in a clockwise direction (opposite arrow 44) against the torsional force exerted by spring 43 to the position shown in FIG. 4. In the position of FIG. 4, abutment surface 46 engages microswitch 48 to provide an electrical output signal. Thus, the output of microswitch 48 provides an indication of belt webbing tension exceeding a threshold value. In a preferred application, this would correspond with the tension typically exerted upon the insulation of a child restraint system. Between the low and high tension positions, respectively, the belt moves from the highly deflected routing shown in FIG. 3 to the lesser deflected position shown in FIG. 4. Dimension 60 in FIG. 3 illustrates the higher level of deflection in the low tension position, as compared with FIG. 4. Deflection can be regarded as the magnitude of deviation of the belt from a straight line condition when tension forces are exerted.

The torsional force exerted by torsion spring 43 can be tuned to vehicle geometry. Similarly, the positioning of pivoting web guide 38 can also be tuned to specific vehicle geometry in order to provide the desired deflected belt routing in the low and high tension conditions. It is also possible to utilize a web guide 38 which does not move purely in a rotational sense, but could move along some other path, such as linearly, against a restoring spring force (presented as an alternate embodiment discussed below). In any event, tension on the seat belt webbing causing it to straighten against the force of a spring and the consequential movement of the web guide will be detected by an electrical sensor to provide the desired belt tension output signal.

FIG. 5 illustrates retractor 50 in accordance with a second embodiment of the present invention. Retractor 50 shares many components with retractor 24 which are identified by the same reference numbers and are described previously. Retractor 50 differs from retractor 24 in that web guide 52 does not pivot in the manner of web guide 38, but instead moves generally in a linear direction. A pair of springs 54 and 56 suspend web guide 52 and allow it to move in a generally linear direction along arrow 58 when a tension force is applied to belt lap belt portion 16. This motion moves abutment surface 46 toward microswitch 48. In all other respects, retractor 50 operates in the manner described previously in connection with retractor 24.

While the above description constitutes the preferred embodiment of the present invention, it will be appreciated that the invention is susceptible to modification, variation and change without departing from the proper scope and fair meaning of the accompanying claims.

What is claimed is:

1. A seat belt retractor for providing extraction and retraction of seat belt webbing of a motor vehicle belt restraint system and having a belt tension sensing feature, comprising:
a retractor frame,
a spool mounted for rotation to the frame,
seat belt webbing wrapped on the spool,
torsion applying means for applying a torsion force on the spool for retracting the webbing,
a webbing guide mounted to the frame having an edge positioned for the webbing to contact the edge and the webbing routed to be deflected as the webbing extends from the spool and exits the retractor, the webbing guide mounted for movement relative to the frame,
biasing means acting on the webbing guide urging the webbing guide toward a low webbing tension position in which the webbing is deflected and a high webbing tension position, and
sensing means for detecting the position of the webbing guide wherein the position of the webbing guide is dependent on the tension applied to the belt webbing.

2. A seat belt retractor according to claim 1 further comprising the webbing guide mounted to the frame for pivoting motion.

3. A seat belt retractor according to claim 2 further comprising the biasing means in the form of a torsion spring biasing the webbing guide to the low webbing tension position.

4. A seat belt retractor according to claim 1 further comprising the torsion applying means in the form of a torsion spring acting on the spool.

5. A seat belt retractor according to claim 1 further comprising wherein the sensing means comprises a micro switch.

6. A seat belt retractor according to claim 1 further comprising wherein the sensing means comprises a Hall effect device.

7. A seat belt retractor according to claim 1 further comprising the edge formed by a slot in the webbing guide.

8. A seat belt retractor according to claim 1 further comprising the high webbing tension position occurring with a webbing tension force of at least about 30 pounds force.

9. A seat belt retractor according to claim 1 wherein the retractor is adapted for engaging a lap belt portion of the vehicle belt restraint system.

10. A seat belt retractor according to claim 1 wherein the belt tension sensing feature is provided infer a presence of an installed child restraint system in a vehicle seat having the retractor, wherein the low webbing tension position is associated with an absence of an installed child restraint system, and the high webbing tension position is associated with the presence of an installed child restraint system.

11. A seat belt retractor according to claim 1 further comprising the webbing guide mounted to the frame for generally linear motion.

12. A seat belt retractor according to claim 11 further comprising the biasing means in the form of at least one spring biasing the webbing guide to the low webbing tension position.

13. A seat belt retractor according to claim 11 further comprising the biasing means in the form of a first and a second spring biasing the webbing guide to the low webbing tension position.

14. A seat belt retractor according to claim 1 further comprising the webbing is deflected to a first extent in the low webbing tension position and to a second extent in the high webbing tension position, wherein the first extent is greater in magnitude than the second extent.
